(19) United States
(12) Patent Application Publication
(10) Pub. No.: US 2012/0164387 A1
(43) Pub. Date: Jun. 28, 2012

(54) Molding Die, Optical Element, and Method of Preparing Molding Die

(76) Inventors: Daisuke Watanabe, Niza-shi (JP); Susumu KOJIMA, Tachikawa-shi ,Tokyo (JP)

(21) Appl. No.: 13/392,745

(22) PCT Filed: Aug. 19, 2010
(86) PCT No.: PCT/JP2010/063983

§ 371 Date: Feb. 27, 2012

(30) Foreign Application Priority Data
Aug. 31, 2009 (JP) 2009-199332

(51) Int. Cl. B29C 33/40; B32B 3/30; B29C 33/44

(52) U.S. Cl. 428/156; 425/436 R; 427/133

(57) ABSTRACT

In the present invention, provided is a molding die with which shape of the molding die can be reliably transferred to a molded material, even though precision molding is conducted at a shape error of 1.0 μm or less. This molding die possesses a glass substrate, at least one resin die formed on the glass substrate, and an inorganic oxide film to cover the glass substrate and the at least one resin, wherein the at least one resin die made of a photo-curable resin has a light transmittance of 20% or more with respect to light having a wavelength of 365 nm and has a hardness of 30-90 in terms of shore D, and the molding die comprises the inorganic oxide film having been subjected to a mold-releasing treatment.

### TECHNICAL FIELD

The present invention relates to a molding die, an optical element and a method of preparing the molding die.

### BACKGROUND

In cases where an optical element is prepared by molding a resin, when repeating the operation by which the profile is transferred from a die (a molding die made of metal) to a resin, lifetime of the die is shortened via high frequency of use, it is not suitable for mass production to prepare the optical element employing the die. For this reason, in recent years, after once preparing a molding die made of a resin as a master die (mother die) for a die, it has been conducted to transfer the profile from a molding die made of the resin to a resin. Since frequency of use of the die as a mother die is reduced by using such a method, the reduced frequency of use is largely possible to extend length of lifetime of the die.

As an example of a molding die made of a resin, a molding die made of an epoxy resin and a molding die made of a urethane resin are disclosed in Patent Documents 1 and 2. Further, molding dies each made of a resin such as a special silicone resin or the like are disclosed in Patent Documents 3-5, and transferability to a molded material is tried to be improved by using a molding die made of such a material.

### PRIOR ART DOCUMENT

### Patent Document

Patent Document 1: Japanese Patent O.P.I. (Open to Public Inspection) Publication No. 5-301227
Patent Document 2: Japanese Patent O.P.I. Publication No. 7-24839
Patent Document 3: Japanese Patent O.P.I. Publication No. 7-178754
Patent Document 4: Japanese Patent O.P.I. Publication No. 7-76303
Patent Document 5: Japanese Patent O.P.I. Publication No. 10-95920

### DISCLOSURE OF THE INVENTION

### Problems to be Solved by the Invention

Incidentally, as is the case where an array type lens or the like is prepared, when a transfer from a molding die to a molded material is accompanied with precision molding leading to a shape error of 1.0 μm or less, it has been confirmed that the molding die is deformed by stress during molding, though not reaching plastic deformation when using the molding die made of a resin, whereby accuracy in transfer from the molding die to the molded material is insufficiently obtained.

Supposedly, even though resins disclosed in Patent Documents 1 and 2 are used, such resins exhibit a mold-releasing property, since it is not easy to release the molded material from the molding die. Those such as a mold-releasing treatment suitable for the molding die made of a resin in high frequency of use, and a mold-releasing treatment to maintain the transfer accuracy are not disclosed in Patent Documents 1 and 2. Further, even though resins disclosed in Patent Documents 1 and 2 are used, it does not appear at present that sufficient transfer accuracy to such an extent that they are applicable to the precision molding is obtained.

Accordingly, it is an object of the present invention to provide a molding die and a preparation method thereof by which shape of a molding die can be reliably transferred to a molded material, even though precision molding is conducted with a shape error of 1 μm or less, and to provide an optical element obtained by utilizing the molding die.

### Means to Solve the Problems

In order to solve the above-described problem, in an embodiment of the present invention, provided is a molding die comprising a glass substrate, at least one resin die formed on the glass substrate, and an inorganic oxide film to cover the glass substrate and the at least one resin, wherein the at least one resin die made of a photo-curable resin has a light transmittance of 20% or more with respect to light having a wavelength of 365 nm and has a hardness of 30-90 in terms of shore D, and the molding die comprises the inorganic oxide film having been subjected to a mold-releasing treatment.

In another embodiment of the present invention, provided is a method of preparing a molding die, comprising the steps of molding a photo-curable resin on a glass substrate; forming at least one resin die having a light transmittance of 20% or more with respect to light having a wavelength of 365 nm and a hardness of 30-90 in terms of shore D, on the glass substrate; forming an inorganic oxide film on surfaces of the glass substrate and the at least one resin die; and conducting a mold-releasing treatment for the inorganic oxide film.

### Effect of the Invention

In the present invention, a molded material can be easily released from a molding die even though precision molding is conducted at a shape error of 1 μm or less when a resin die exhibits hardness at a given level, and an inorganic oxide film is subjected to a mold-releasing treatment, and provided can be a method of preparing a molding die, the molding die and an optical element obtained by using the molding die, by which shape of the molding die can be reliably transferred to the molded material.

### BRIEF DESCRIPTION OF THE DRAWINGS

FIG. 1 is a side view showing a schematic diagram of a molding die as an example in a preferred embodiment of the present invention.

FIG. 2 shows a schematic diagram (plan view) to explain a method of preparing a molding die in FIG. 1.

FIG. 3 shows a schematic diagram (side view) to explain a method of preparing a molding die in FIG. 1.

### DESCRIPTION OF THE EMBODIMENTS

Next, preferred embodiments of the present invention will be described referring to drawings.

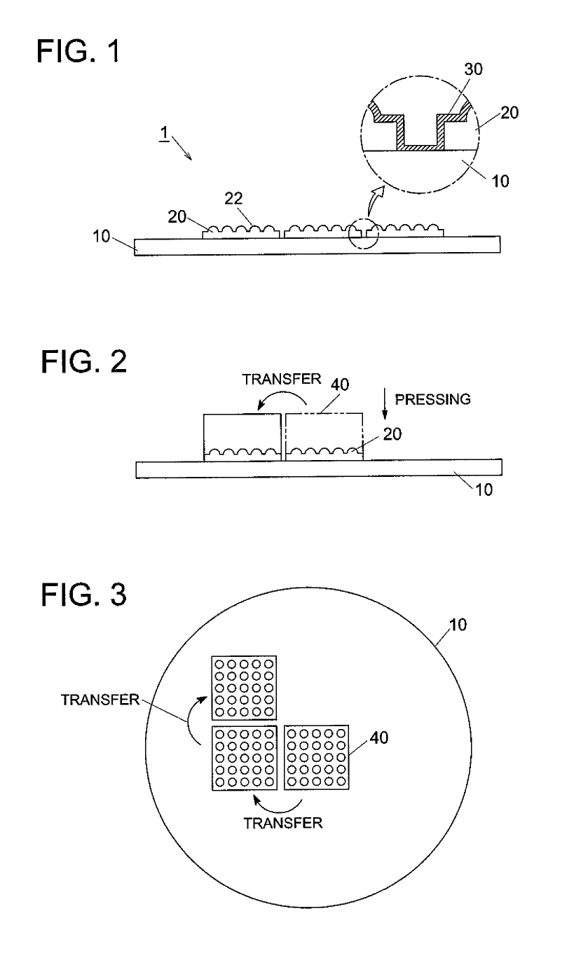

As shown in FIG. 1, molding die 1 in the preferred embodiments of the present invention possesses planar glass substrate 10 and provided thereon, plural resin dies 20.

Resin dies 20 are placed on glass substrate 10 at fine intervals each between the resin dies. Plural convex protrusions 22 are formed on the surface of each of resin dies 20.

Resin die 20 has a light transmittance of 20% or more with respect to light having a wavelength of 365 nm, and has a hardness of 30-90 in terms of shore D. In addition, in the case of a light transmittance of less than 20% with respect to light having a wavelength of 365 nm, a very long period of time is consumed to conduct photo-curable reaction via transmission of resin die 20, and shortage of hardness is also caused upon no exposure to light having a short wavelength. “Shore D” represents hardness measured in accordance with a method specified by JIS K6253.

Resin die 20 exhibiting such properties is made mainly of a photo-curable resin, and for example, is made of a resin described in each of the following (1), (2), (3) and (4).

A commonly known initiator is usable for the photo-curable resin, depending on kinds of the resin (monomer), and the photo-curable resin may also be a resin exhibiting a radical polymerization property, a cationic polymerization property or a polycondensation property.

### (1) Acrylic Resin

(Meth)acrylate used for a polymerization reaction is not specifically limited, and the following (meth)acrylate prepared by conventional preparation methods are usable. Examples thereof include ester (meth)acrylate, urethane (meth)acrylate, epoxy (meth)acrylate, ether (meth)acrylate, alkyl (meth)acrylate, alkylene (meth)acrylate, (meth)acrylate having an aromatic ring, (meth)acrylate having an alicyclic structure, and so forth. These are used singly, or in combination with at least two kinds thereof.

Specifically, (meth)acrylate having an alicyclic structure is preferable, and the alicyclic structure may contain an oxygen atom or a nitrogen atom. Examples thereof include cyclohexyl (meth)acrylate, cyclopentyl (meth)acrylate, cycloheptyl (meth)acrylate, bicycloheptyl (meth)acrylate, tricyclo decyl (meth)acrylate, tricyclodecane, dimethanol (meta)acrylate, isobornyl (meta)acrylate, (meta)acrylate classified as hydrogenerated dibisphenol, and so forth. Further, compounds each having an adamantane moiety are preferable. Examples thereof include 2-alkyl 2-adamantyl (meth)acrylate (refer to Japanese Patent O.P.I. Publication No. 2002-193883), adamantyl di(meta)acrylate (refer to Japanese Patent O.P.I. Publication No. 57-500785), adamantyl dicarboxylic acid diallyl (refer to Japanese Patent O.P.I. Publication No. 60-100537), perfluoroadamantyl acrylic acid ester (refer to Japanese Patent O.P.I. Publication No. 2004-123687), 2-methyl-2-adamantyl methacrylate produced by Shin-Nakamura Chemical Co., Ltd., 1,3-adamantane diol diacrylate, 1,3,5-adamantane triol triacrylate, unsaturated carboxylic acid adamantyl ester (refer to Japanese Patent O.P.I. Publication No. 2000-119220), 3,3′-dialkoxycarbonyl-1,1′biadamantane (refer to Japanese Patent O.P.I. Publication No. 2001-253835), 1,1′-biadamantane compound (refer to U.S. Pat. No. 3,342,880), tetra adamantane (refer to Japanese Patent O.P.I. Publication No. 2006-169177), 2-alkyl-2-hydroxy adamantane, 2-alkylene adamantane, a curable resin having an adamantane moiety including no aromatic ring such as 1,3-adamantane di-tert-butyl dicarboxylate or the like (refer to Japanese Unexamined Patent Publication No. 2001-322950), bis(hydroxyphenyl)adamantanes, bis(glycidyl oxyphenyl)adamantane (refer to Japanese Patent O.P.I. Publication No. 11-35522 and Japanese Patent O.P.I. Publication No. 10-130371), and so forth.

Besides, reactive monomers are also possible to be contained.

Examples of (meth)acrylate include methyl acrylate, methyl methacrylate, n-butyl acrylate, n-butyl methacrylate, 2-ethyl hexyl acrylate, 2-ethyl hexyl methacrylate, isobutyl acrylate, isobutyl methacrylate, tert-butyl acrylate, tert butyl methacrylate, phenyl acrylate, phenyl methacrylate, benzyl acrylate, benzyl methacrylate, cyclohexyl acrylate, cyclohexyl methacrylate and so forth.

Examples of polyfunctional (meth)acrylate include trimethylolpropane tri(meth)acrylate, pentaerythritol tetra (meth)acrylate, pentaerythritol tri (meth)acrylate, dipenta erythritol hexa (meth)acrylate, dipenta erythritol penta (meth)acrylate, dipenta erythritol tetra (meth)acrylate, dipentaerythritol in (meta)acrylate, tripenta erythritol octa (meth)acrylate, tripentaerythritol hepta (meta)acrylate, tripenta erythritol hexa (meth)acrylate, tripenta erythritol penta (meth)acrylate, tripenta erythritol tetra (meth)acrylate, tripentaerythritol tri(meta)acrylate and so forth.

### (2) Allyl Ester Resin

The allyl ester resin has an allyl group and is a resin cured via radical polymerization, and those described below are cited, but the present invention is not specifically limited thereto.

Examples thereof include bromine-containing (meth)allyl ester containing no aromatic ring (refer to Japanese Patent O.P.I. Publication No. 2003-66201), allyl (meth)acrylate (refer to Japanese Patent O.P.I. Publication No. 5-286896), an allyl ester resin (refer to Japanese Patent Publication No. 5-286896 and Japanese Patent Publication No. 2003-66201), a copolymeric compound of an acrylic acid ester and an epoxy group-containing unsaturated compound (refer to Japanese Patent O.P.I. Publication No. 2003-128725), an acrylate compound (refer to Japanese Patent Publication No. 2003-147072), an acrylic ester compound (refer to Japanese Patent O.P.I. Publication No. 2005-2064) and so forth.

### (3) Epoxy Resin

Epoxy resins are not specifically limited as long as they have an epoxy group, and is a resin polymerization-cured via light or heat, and acid anhydride, a cationic generating agent or the like is usable also as a hardening initiator.

As kinds of epoxy resins exemplified are a novolak phenol type epoxy resin, a biphenyl type epoxy resin and a dicyclopentadiene type epoxy resin. Examples thereof include bisphenol F diglycidyl ether, bisphenol A diglycidyl ether, 2,2′-bis(4-glycidyl oxycyclohexyl)propane, 3,4-epoxycyclohexyl methyl-3,4-epoxycyclohexane carboxylate, vinylcyclohexene dioxide, 2-(3,4-epoxycyclohexyl)-5,5-spiro(3,4-epoxycyclohexane)-1,3-dioxane, bis(3,4-epoxycyclohexyl)adipate, 1,2-cyclopropane dicarboxylic acid bisglycidyl ester and so forth.

### (4) Silicone Resin

In the present invention, a silicone resin having a siloxane bond of Si—O—Si as a main chain is usable. As the silicone resin, a silicone based resin made of a polyorganosiloxane resin in a predetermined amount is usable (refer to Japanese Patent O.P.I. Publication No. 6-9937).

The polyorganosiloxane resin is not specifically limited, as long as it has a three-dimensional reticular structure having a siloxane bond moiety via continuous hydrolysis-dehydrating condensation reaction by heat. Such a resin generally exhibits hardenability by heating for a long period of lime, and exhibits a property in which it is difficult to be softened again via heating one it has been cured.

Such a polyorganosiloxane resin contains the following Formula (A) as a constituting unit, and its configuration may be any one of a chain, a ring, and a reticular configuration.

[(R₁)(R₂)SiO]ₙ Formula (A)

In the above-described Formula (A), (R₁) and (R₂) each are identical to each other or different from each other, or are a substituted or unsubstituted monovalent hydrocarbon group. Examples of (R₁) and (R₂) include an alkyl group such as a methyl group, an ethyl group, a propyl group, a butyl group or the like; an alkenyl group such as a vinyl group, an allyl group or the like; an allyl group such as a phenyl group, a tolyl group or the like; a cycloalkyl group such as a cyclohexyl group, a cyclooctyl group or the like; and groups in which hydrogen atoms bonded to carbon atoms in these groups are substituted by a halogen atom, a cyano group, an amino group, or the like, for example, a chloromethyl group, a 3,3,3-trifluoropropyl group, a cyanomethyl group, a γ-aminopropyl group, a N-(β-aminoethyl)-γ-aminopropyl group and so forth. (R₁) and (R₂) may be groups selected from a hydroxyl group and an alkoxy group. Further, in the above-described Formula (A), “n” represents an integer of 50 or more.

The polyorganosiloxane resin is conventionally used by dissolving it in a hydrocarbon based solvent such as toluene, xylene or a petroleum based solvent, or in a mixture of this hydrocarbon based solvent with a polar solvent. Further, another solvent having a different composition may be blended within the range where these solvents are dissolved to each other.

A method of preparing the polyorganosiloxane resin is not specifically limited, and any of commonly known methods is also usable. For example, the polyorganosiloxane resin can be obtained via hydrolysis or alcoholysis of one kind of organohalogenosilane or mixture of at least two kinds of organohalogenosilane, and the polyorganosiloxane resin generally contains a hydrolyzable group such as a silanol group, an alkoxy group or the like and contains 1-10% by weight of each of these groups in conversion with respect to the silanol group.

The above-described reaction is generally performed in the presence of a solvent capable of dissolving organohalogenosilane. Further, the polyorganosiloxane resin can be obtained by a method of synthesizing a block copolymer via hydrolysis of straight-chained polyorganosiloxane having hydroxyl group, an alkoxy group or a halogen atom at the molecular chain terminal, with organotrichlorosilane. The polyorganosiloxane resin obtained in such a manner generally contains residual HCl, but as to the composition in the present embodiment, a HCL content of 10 ppm or less may be used, and a HCL content of 1 ppm or less may be preferably used in view of excellent storage stability.

In addition, as described above, commonly known initiators are usable depending on kinds of photo-curable resins (monomers), and the following initiators are exemplified as usable initiators.

Usable examples of photo-polymerization initiators in relation to acrylic resins include benzophenones, acetophenone, benzoin, benzoin ethylether, benzoin isobutylether, benzilmethyl ketone, azobisisobutyronitile, hydroxycyclohexylphenyl ketone, 2-hydroxy-2-methyl-1-phenylpropane-1-on and so forth.

These photo-polymerization initiators may be used singly, or in combination with at least two kinds thereof. Further, an amine compound, a phosphorous compound or the like as a photosensitizes can be added therein to further accelerate polymerization.

As a photo-polymerization initiator in relation to an epoxy resin, usable is a photo-radical polymerization initiator, a photo-cationic polymerization initiator or the like.

Examples of the photo-radical polymerization agent include α-diketones such as benzil, diacetyl and so forth; acyloins such as benzoin and so forth; acyloin ethers such as benzoin methylether, benzoin ethylether, benzoin isopropylether and so forth; benzophenones such as thioxanthone, 2,4-diethylthioxanthone, thioxanthone-4-sulfonic acid, benzophenone. 4,4′-bis(dimethylamino)benzophenone, 4,4′-bis(diethylamino)benzophenone and so forth; acetophenones such as acetophenone, p-dimethylaminoacetophenone, α,α′-dimethoxyacetoxybenzophenone, 2,2′-dimethoxy-2-phenylacetophenone, p-methoxyacetophenone, 2-methyl[4-(methylthio)phenyl]-2-morpholino-1-propane, 2-benzil-2-dimethylamino-1-(4-morpholinophenyl)-butane-1-on and so forth; quinines such as anthraquinone, 1,4-naphthoquinone and so forth; halogen compounds such as phenacyl chloride, tribromomethylphenylsulfone, tris(trichloromethyl)-s-triazine and so forth; and peroxides such as di-t-butylperoxide and so forth.

Commercially available products as described below are usable as photo-cationic polymerization initiators. Examples of the commercially available products which are suitably usable include Uvacure 590 (produced by Daicel-Cytec Co., Ltd.); UVI-6950, UVI-6970, UVI-6974 and UVI-6990 (produced by Union Carbide Corp.); Adekaoptomer-SP-150, Adekaoptomer-SP-151, Adekaoptomer-SP-170 and Adekaoptomer-SP-171 (produced by Adeka Corp.); Irgacure 261 (produced by BASF Japan Ltd.); CI-2481, CI-2624, CI-2639 and CI-2064 (produced by Nippon Soda Co., Ltd.); CD-1010, CD-1011 and CD-1012 (produced by Sartomer Company, Inc.); DTS-102, DTS-103. NAT-103, NDS-103, TPS-103, MDS-103, MPI-103 and BBI-103 (Midori-Kagaku Co., Ltd.); and so forth.

As shown in FIG. 1, molding die 1 possesses inorganic oxide film 30, and inorganic oxide film 30 covers not only the surface of resin die 20, but also the surface of glass substrate 10 (The surface of glass substrate 10 exposed in each gap between resin dies 20 is included. Refer to an enlarged view in FIG. 1).

SiO₂, Al₂O₃, TiO₂ or the like is used as inorganic oxide constituting inorganic oxide film 30, and inorganic oxide film 30 has been treated with a mold-releasing agent (has been subjected to a mold-releasing treatment).

Next, a method of preparing molding die 1, and a method of preparing an optical element employing the molding die will be described.

As shown in FIG. 2, a photo-curable resin is dispensed (dropped) at the predetermined position of glass substrate 10, and metal die 40 (mother die) is pressed with respect to the resin, followed by exposure to light. Subsequently, such an operation is sequentially repeated as shown in FIGS. 2 and 3 to form plural resin dies 20 one by one on glass substrate 10.

In addition, molding die 1 may possess only one resin die 20. In this case, each of dispensing a resin on glass substrate 10, pressing mother die 40, and exposure to light is not necessary to be repeated, and simply, mother die 40 may be pressed, followed by exposure to light after dispensing a resin on glass substrate 10.

Subsequently, inorganic oxide film 30 is formed on the surface of glass substrate 10 as well as the surface of resin die 20.

Thereafter, inorganic oxide film 30 is subjected to a mold-releasing treatment with a mold-releasing agent.

As a mold-releasing agent, a compound to which a hydrolyzable functional group is bonded at the terminal, like a silane coupling agent structure, that is, a compound having a structure in which bonding is produced via dehydration and condensation or hydrogen bonding among with OH groups present on the surface of inorganic oxide film 30 (metal).

In the case of a mold-releasing agent having a silane coupling structure at one terminal and mold-releasing function at another terminal, as the number of OH groups formed on the surface of inorganic oxide film 30 is greater, portions where covalent bonding on the surface of inorganic oxide film 30 is present are to be increased, resulting in appearance of more rigid bonding. As a result, the mold-releasing effect is not reduced even though molding is repeated many times, whereby durability is improved.

Preferred examples of the material to which a hydrolyzable functional group is bonded at the terminal include materials each having an alkoxysilane group, a halogenated silane group, a quaternary ammonium salt or a phosphoric acid ester group as a functional group. Further, a group to be strongly bonded at the terminal to a die, like triazinethiol, for example, is allowed to be used. Specifically, it is a compound having an alkoxy silane group represented by the following Formula (B) or a halogenated silane group represented by the following Formula (C).

—Si(OR¹)ₙR²₃₋ₙ Formula (B)

—SiXmR³₃₋ₘ Formula (C)

In the above-described. Formulae (B) and (C), each of Wand R² represents an alkyl group (for example, a methyl group, an ethyl group, a propyl group, a butyl group or the like); and each of n and m is 1, 2 or 3; R³ is an alkyl group (for example, a methyl group, an ethyl group, a propyl group, a butyl group or the like) or an alkoxy group (for example, a methoxy group, an ethoxy group, a butoxy group or the like). X represents a halogen atom (for example, Cl, Br or I).

Further, when at least two R³s are bonded to a Si atom, two R³s, for example, may be different from each other so as to be an alkyl group and an alkoxy group within the range of the above-described groups or atoms. Further, when at least two of R₁, R², R³ and X are bonded to a Si atom, they, for example, may be different from each other so as to be an alkyl group, a methyl group and an ethyl group within the range of the above-described groups or atoms.

An alkoxy silane group —SiOR¹ and a halogenated silane group —SiX become —SiOH via reaction with water, and bonding is further conducted via dehydration and condensation or hydrogen bonding between —SiOH and OH groups present on the surface of inorganic oxide film 30.

The following formulae of reaction between a mold-releasing agent in which an alkoxy silane group is used at the terminal as an example of a hydrolyzable functional group, and OH groups on the surface of inorganic oxide film 30.

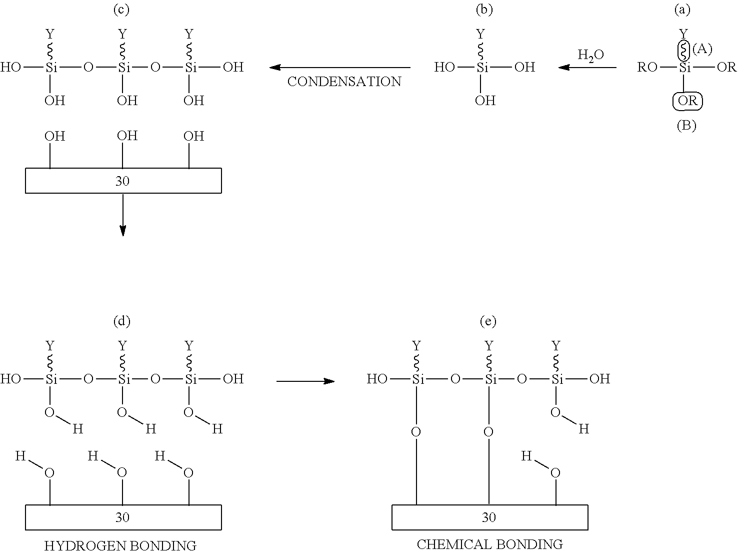

In reaction formula (a), (A) represents a main chain exhibiting mold-releasing function, and —OR represented by (B) represents an alkoxy group as a hydrolyzable functional group. AS the alkoxy group represented by (B), cited are methoxy (—OCH₃) and ethoxy (—OC₂H₅). Methanol (CH₃OH) and ethanol (C₂H₅OH) are generated via hydrolysis to produce silanol (—SiOH) represented by reaction formula (b). After this, a condensate of silanol as shown in reaction formula (e) is generated by partial dehydration and condensation. Further, adsorption occurs via hydrogen bonding between OH groups and the surface of inorganic oxide film 30 as shown in reaction formula (d), and bonding (covalent bonding) finally takes place via dehydration as shown in reaction formula (e).

In addition, the case of an alkoxy silane is exemplified in the above-described reaction formulae, but the same reaction as in the case of the alkoxy silane is produced also in the case of a halogenated silane group.

That is, a mold-releasing agent used in the present invention is chemically bonded to the surface of inorganic oxide film 30 at one terminal, and a functional group is oriented at another terminal, whereby inorganic oxide film 30 is to be covered. Thus, a thin, uniform mold-releasing layer exhibiting excellent durability can be formed.

As a structure on the side having mold-releasing function, preferred are those having low surface energy, for example, a fluorine-substituted hydrocarbon group or a hydrocarbon group.

### (Fluorine-Based Mold-Releasing Agent on Functional Side)

The fluorine-substituted hydrocarbon group is preferably a fluorine-substituted hydrocarbon group having a perfluoro group (a and b each representing an integer) such as CF₃(CF₂)ₐ— group, CF₃.CF₃.CF(CF₂)_{b}— group or the like at one terminal of a molecular structure. Further, length of the perfluoro group is equivalent to at least two carbon atoms. The number of the CF₂ groups following the CF₃ of the CF₃(CF₂)ₐ— is preferably 5 or more.

The perfluoro group is not necessarily straight-chained, and may have a branched chain structure. To cope with the recent environmental problems, such a structure as CF₃(CF₂)_{c}—(CH₂)_{d}—(CF₂)ₑ— may also be accepted. In this case, c is 3 or less, d represents an integer (preferably 1), and e is 4 or less.

The above-described fluorine mold-releasing agent is usually solid. In order to coat this agent on the surface of inorganic oxide film 30, a fluorine mold-releasing agent solution dissolved in an organic solvent should be made. Though there is a difference depending on the molecular structure of the mold-releasing agent, a hydrocarbon fluoride based solvent or one in which an organic solvent is mixed in the foregoing solvent is suitable as the solvent in many cases. The concentration of the solvent is not specifically limited, but one having a low concentration is sufficient, and a concentration of 1-3% by weight is preferable, since it is a feature that the mold-releasing film to be used is particularly thin.

In order to coat this fluorine mold-releasing agent solution on the surface of inorganic oxide film 30, it is possible to use a conventional wet coating method such as a dip coating method, a spray coating method, a brush coating method, a spin coating method or the like. After coating, the solvent is conventionally evaporated by natural drying to obtain a dry coating film. The coating film thickness in this case is not specifically limited, but is preferably 20 μm or less.

Examples of fluorine mold-releasing agents include OPTOOL DSX produced by Daikin Industries Ltd., DURASURF HD-1100 produced by Daikin Industries Ltd., and DURASURF HD-2100 produced by Daikin Industries Ltd.; NOBECK EGC1720 produced by Sumitomo 3M Limited; vapor deposition of triazinethiol produced by Takeuchi Shinkuhimaku Co., Ltd.; amorphous fluorine SAITOP Grade M produced by AGC, and stain proof coat OPC-800 produced by N.I.Material.

### (Hydrocarbon-Based Mold-Releasing Agent on Functional Side)

The hydrocarbon group may be straight-chained so as to be CₙH₂ₙ₊₁, or may be branched. The silicone-based mold-releasing agent is included in this classification.

Many compositions have been commonly known as a composition containing an organic siloxane resin as a main component, and a composition to form a cured coating film exhibiting water repellency. For example, Japanese Patent O.P.I. Publication No. 55-48245 proposes a composition to form a coating film exhibiting water repellency together with excellent mold-releasing and stain-proof properties via curing, wherein the coating film is made from a methylpolysiloxane resin containing a hydroxyl group, α,ω-dihydroxy diorgano polysiloxane and organosilane. Further, Japanese Patent O.P.I. Publication No. 59-140280 proposes a composition having a partially cohydrolyzed condensate of an organosilane possessing organosilane containing a perfluoroalkyl group and organosilane containing an amino group as main components, the composition to form a cured film exhibiting excellent water repellency and oil repellency.

Specific examples include MOLD SPAT produced by AGC Seimi Chemical Co., Ltd., ORGATICS SIC-330 and ORGATICS SIC-434 produced by Matsumoto Fine Chemical Co., Ltd., SR-2410 produced by Toray Dow Chemical Co., Ltd., and so forth. SAMLAY produced by Nippon Soda Co., Ltd. can be also cited as a self-organizing monomolecular film.

In addition, the effect as mold-releasing agent can not be produced unless the surface of resin die 20 is coated by inorganic oxide film 30, since the above-described mold-releasing agent is bonded to OH groups present on the surface of inorganic oxide film 30 via silane coupling reaction.

Inorganic oxide film 30 is subjected to the above-described mold-releasing treatment to prepare molding die 1.

In the present embodiment, optical elements each made of a resin can be prepared employing molding die 1.

For example, a predetermined resin is dispersed (dropped) on a glass substrate in the form of a wafer, and molding die 1 (resin die 20) is pressed with respect to the resin to cure the resin. Thus, a so-called wafer lens possessing a glass substrate and provided thereon, plural resin portions (concave lenses each made a resin) can be prepared.

In this case, in the present embodiment, since resin die 20 exhibits hardness at a given level, and inorganic oxide film 30 is subjected to a mold-releasing treatment, a wafer lens can be easily released from molding die 1, and a profile of resin die 20 (convex portions 22 in shape) in molding die 1 can be reliably transferred to a resin of a wafer lens.

In addition, concave portions in place of convex portions 22 may be formed on the surface of resin die 20, and in this case, convex lenses each made of a resin can be prepared with molding die 1.

Further, in place of using molding die 1 as a direct die when preparing an optical element made of a resin, molding die 1 may be used as an indirect die to form the optical element, including the case where concave portions are formed on resin die 20. In this case, molding die 1 (convex portions 22) is used as the first die; the second die (concave portions) is formed from the first die; and an optical element (convex portions each made of a resin) can be prepared from the second die (concave portions).

### Example

### (1) Preparation of Sample

Dispensing a resin (detailed in Table 1) on the entire surface of a 10.2 em (4 inches) glass substrate, pressing of a spherical die (a depth of 0.35 mm, φ2, and R4), and exposure to light were repeatedly conducted while transferring the spherical die to form plural resin dies. Thereafter, as to each of the resulting resin dies, hardness (measured in accordance with a method specified by JIS K 6253) and spectral transmittance with respect to light having a wavelength of 365 nm (measured by a 330 type recording spectrophotometer, manufactured by Hitachi Ltd.) are measured, and the measured results are shown in Table 1.

Thereafter, an inorganic oxide film (refer to Table 1) was formed on each resin die and a glass substrate exposed in each gap between resin dies, by evaporation. Then, a mold-releasing agent (OPTOOL DSX, produced by Daikin Industries Ltd.) was coated on the inorganic oxide film, and the inorganic oxide film was subjected to a mold-releasing treatment to prepare Samples 1-17 as plural molding dies in response to resin kinds and so forth.

### (2) Measurement of Surface Profile

Optical elements each made of a resin were prepared (molded) from each molding die, and surface profile of each optical element was measured to evaluate whether the molding die is good or not. Variation (shape error) made from a designed value of the surface profile was measured employing a non-contact surface profiler to measure the surface profile. The measured results are shown in Table 1. In addition, criteria of A, B, C and D described in Table 1 are shown below.

A: a variation (shape error) of less than 200 nm
B: a variation (shape error) of not less than 200 nm and less than 500 nm
C: a variation (shape error) of not less than 500 nm and less than 1.0 μm
D: a variation (shape error) of less than 1.0 μm

### (3) Evaluation of Mold-Releasing Property

When preparing an optical element made of a resin employing each molding die, a mold-releasing property of the molding die prepared after conducting the first molding was evaluated. One in which a molded optical element can be released from a molding die in the state where the surface profile was maintained was evaluated as “Pass”, and one in which a molded optical element can not be released from a molding die in the state where the surface profile was maintained was evaluated as “Fail”. The evaluated results are similarly shown in Table 1.

TABLE 1

| | Resin die | | | | | | |
|---|---|---|---|---|---|---|---|
| | | | Inorganic | Hardness | Transmittance | Mold-releasing | Profile |
| Sample | Resin material | Initiator | oxide film | (Shore D) | (%) | property | stability |
| 1 | Acryl (A-DCP produced by | Peroxide ester | SiO₂ | 50 | 65 | Pass | C |
| 2 | Shin-Nakamura Chemical Co., | (PERBUTYLR O | Al₂O₃ | 50 | 60 | Pass | C |
| 3 | Ltd.) | produced by NOF | TiO₂ | 50 | 60 | Pass | C |
| 4 (Comparative | | Corp.) | — | 50 | 65 | Fail | C |
| example) | | | | | | | |
| 5 (Comparative | Acryl (A-IB produced by Shin- | | SiO₂ | 100 | 65 | Pass | Fail |
| example) | Nakamura Chemical Co., Ltd.) | | | | | | |
| 6 | Bisphenol A type epoxy | 3-methyl-hexahydro | SiO₂ | 60 | 40 | Pass | A |
| 7 | | phthalic anhydride | Al₂O₃ | 60 | 30 | Pass | A |
| 8 (Comparative | | | — | 60 | 40 | Fail | A |
| example) | | | | | | | |
| 9 | | Diethylenetriamine | SiO₂ | 70 | 35 | Pass | A |
| 10 | | Aromatic sulfonium | SiO₂ | 90 | 35 | Pass | A |
| 11 | Bisphenol A type epoxy:X | 3-methyl-hexahydro | SiO₂ | 70 | 55 | Pass | Pass |
| 12 | (=7:3) | phthalic anhydride | Al₂O₃ | 70 | 50 | Pass | Pass |
| 13 | | | TiO₂ | 70 | 50 | Pass | Pass |
| 14 (Comparative | Dimethyl silicone | — | SiO₂ | 20 | 90 | Pass | Fail |
| example) | | | | | | | |
| 15 | Methylphenyl silicone | | SiO₂ | 30 | 90 | Pass | C |
| 16 | Diphenyl silicone | | SiO₂ | 40 | 90 | Pass | Pass |
| 17 | | | Al₂O₃ | 40 | 85 | Pass | Pass |

### (4) Conclusion

As is clear from Table 1, when Samples 1-4, 6-13, and 15-17 of the present invention were compared with Samples 4 and 14 as comparative examples, optical elements prepared from Samples 1-4, 6-13, and 15-17 exhibited stable surface profile.

Further, Samples 4 and 8 as comparative examples having been subjected to a mold-releasing treatment without forming an inorganic oxide film were not able to be mold-released in the state where the surface profile of a molded element was maintained.

Considering those mentioned above, it is to be understood that it leads to an excellent mold-releasing property and useful transferability of shape of a molding die reliably to a molded material, when forming the molded material from the molding die, that the resin die exhibits hardness at a given level, and an inorganic oxide film is subjected to a mold-releasing treatment.

### EXPLANATION OF NUMERALS

1 Molding die
10 Glass substrate
20 Resin die
22 Convex portion
30 Inorganic oxide film
40 Die

1. A molding die comprising a glass substrate, at least one resin die formed on the glass substrate, and an inorganic oxide film to cover the glass substrate and the at least one resin,
wherein the at least one resin die made of a photo-curable resin has a light transmittance of 20% or more with respect to light having a wavelength of 365 nm and has a hardness of 30-90 in terms of shore D, and the molding die comprises the inorganic oxide film having been subjected to a mold-releasing treatment.

2. The molding die of claim 1,
wherein the photo-curable resin comprises a resin exhibiting a radical polymerization property.

3. The molding die of claim 1,
wherein the photo-curable resin comprises a resin exhibiting a cationic polymerization property.

4. The molding die of claim 1,
wherein the photo-curable resin comprises a resin exhibiting a polycondensation property.

5. An optical element molded with a molding die of claim 1.

6. A method of preparing a molding die, comprising the steps of:
molding a photo-curable resin on a glass substrate;
forming at least one resin die having a light transmittance of 20% or more with respect to light having a wavelength of 365 nm and a hardness of 30-90 in terms of shore D, on the glass substrate;
forming an inorganic oxide film on surfaces of the glass substrate and the at least one resin die; and
conducting a mold-releasing treatment for the inorganic oxide film.

7. The method of claim 6,
wherein the step of forming the at least one resin die comprises forming the at least one resin die one by one on the glass substrate while transferring a mother die.
